(19) United States
(12) Patent Application Publication
(10) Pub. No.: US 2017/0348966 A1
(43) Pub. Date: Dec. 7, 2017

(54) Embedded Color Bar and Method

(71) Applicant: Goss International Americas, Inc., Durham, NH (US)

(72) Inventors: Peter Walter Walczak, Lee, NH (US); Christopher Thomas Brooks, Rochester, NH (US); John Joseph Kulak, West Simsbury, CT (US); Brian Robert Elkinson, Barrington, NH (US)

(21) Appl. No.: 15/435,472

(22) Filed: Feb. 17, 2017

Related U.S. Application Data
(60) Provisional application No. 62/297,064, filed on Feb. 18, 2016.

(51) Int. Cl. B41F 33/00

(52) U.S. Cl. CPC B41F 33/0045; B41F 33/0081

(57) ABSTRACT

A printed substrate is provided. The printed substrate includes a plurality of color bars printed on a substrate, a space between each of the plurality of color bars and an image printed in the space between at least two of the color bars. An embedded color bar and a method of printing an embedded color bar are also provided.

### CROSS REFERENCE TO RELATED APPLICATIONS

Priority is hereby claimed to U.S. Provisional Application No. 62/297,064, the entire disclosure of which is hereby incorporated by reference herein.

The present invention relates generally to printing presses and more particularly to color bars for controlling color, registration and ink on a printed substrate.

### BACKGROUND

U.S. Pat. No. 8,763,528, hereby incorporated by reference herein, discloses a color control system for use in a printing press. The system includes a controller for reviewing digital data for a print job and identifying solid color regions of the print job that are greater than a predetermined size, a user interface allowing an operator to select solid color regions identified by the controller, a sensor for measuring a characteristic of the selected solid color regions of the print job, on a printed substrate, the controller determining measured values of the characteristic for each of the selected solid color regions, and at least one inking unit for supplying ink in a plurality of ink zones to a plate cylinder, the controller varying the ink supplied to ink zones including the solid color regions as function of a difference between the measured value of the characteristic of each selected solid color region and a predetermined target value of the characteristic.

Color bars are used to control ink on printed substrate. The color bar is printed on the substrate and thus requires a clear space on the substrate. The space required on the substrate is wasted and the color bar can impact the look of the printed substrate and/or final product if the color bar is embedded in the finished product. Typically this limits the use of color bars into finished products in packaging, for example, film or board type packaging. The color bars may be cut away or discarded from the final product, which may require an additional production step.

In order to reduce the negative impact of the color bar on the final products attempts have been made to remove the color bar entirely. Another alternative has been to control color by using the printed image on the substrate. These attempts have been met with little to no success.

Customer complaints about the web offset printing process in packaging require the printing of color bars in order to control color automatically. Many finished products, for example, labels, pouches and bags, have no location to hide the color bars. Customers find this unacceptable. As a result, the printer of the packaging has to print the packaging without the color bars and thus, without the automatic control of the color. This creates more printed waste. It is not desirable to lack online color control of the printed images.

### BRIEF SUMMARY OF THE INVENTION

The embedded color bar, according to the present invention, uses the smallest color bar available for both color and register control. Between each section of color bar, an image of the product may be printed. This differs from the known art, in which the area between the color bars remains unprinted. By filling in the space between each color bar, the bar seems smaller to the end user and the image is far easier to work into the finished product design.

The present invention provides a printed substrate including a plurality of color bars printed on a substrate, a space between each of the plurality of color bars, and an image printed in the space between at least two of the color bars.

The present invention also provides an embedded color bar including at least one color bar printed on a substrate and an image printed adjacent the at least one color bar on the substrate.

The present invention further provides a method of printing an embedded color bar including the steps of printing at least one color bar on a substrate and printing an image adjacent the at least one color bar.

### BRIEF DESCRIPTION OF THE DRAWINGS

A preferred embodiment of the present invention will be elucidated with reference to the drawings, in which:

FIGS. 1 and 4A show color bars printed on a substrate as known in the art; and

FIGS. 2, 3 and 4B show a printed substrate having an embedded color bar in accordance with the present invention.

### DETAILED DESCRIPTION OF PREFERRED EMBODIMENTS

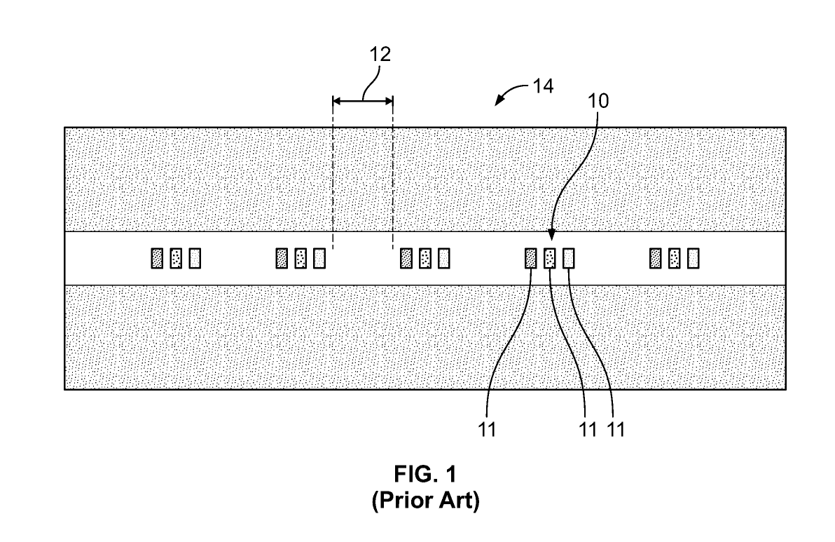

FIG. 1 shows a plurality of standard color bars 10 printed on a substrate 14 with an unprinted space 12 between each color bar 10. Each color bar may include multiple targets 11 and each target may represent a color, for example, cyan, magenta, black or yellow.

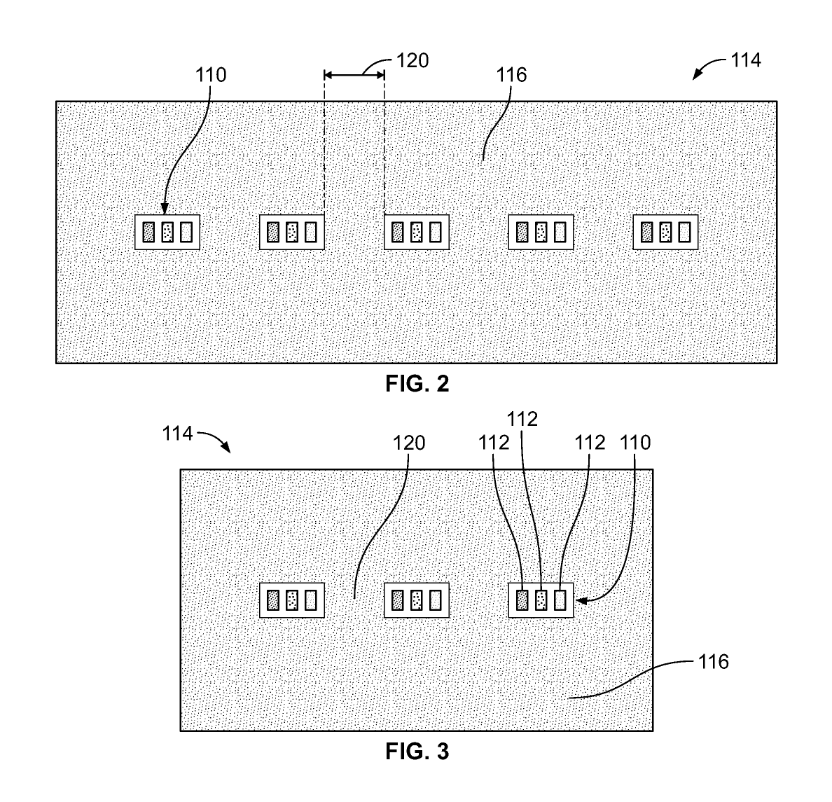

As shown in FIGS. 2 to 4, a plurality of color bars 110 are printed on a substrate 114. Each color may include a plurality of targets 112, for example, three, four or seven. Each target may be a solid density block of a different color, for example, cyan, magenta, black and yellow, green, blue, orange. A printed image 116 is also printed on the substrate, the printed image is the desired image for the substrate. The image 116 is printed in space 120 between two color bars 110 or adjacent a single color bar 110. Thus, color bars 110 are embedded in printed image 116. Consequently, the portion of the substrate 114 with color bars 110 is notcut away and discarded as waste.

A height of color bar 110 may be, for example, 0.095″. This dimension can also be decreased to approximately 0.065.″ A width of color bar 110 varies with the number of targets 112. For example, a color bar 110 including four targets 112 may have a width of 0.300″ whereas a color bar 110 having seven targets 112 may have a width of 0.450″. A distance between the center points of two color bars 110 adjacent one another may be, for example, 40 mm for bars having seven targets 112.

Each target may be, for example, 0.025″ by 0.035″. A space between each target may be as small as 0.015″, however 0.020″ may be preferable in order to accommodate for fan out on wide presses. Since each color is print by a different print unit it may also be beneficial to have approximately 0.020″ of space between targets 112 to accommodate for any variation in registration or alignment between print units. The total area of targets 112 is important in order to get an accurate reading. There can be variation in the length and width dimensions of targets 112, but it is preferable to keep the minimum dimensions to 0.020″ to maintain integrity of the print quality. Smaller dimensions may be more difficult for a closed loop color control system to find the targets 112 if are in the printed image. So the limit on reducing the size of color bar 110 is the ability to print a good quality mark. If the mark is too small, a print defect may affect the accuracy of the measurements. Color bars 110 and targets 112 may be increased in size and the field of view closed loop color control system may be scaled accordingly.

In accordance with the present invention, small color bars 110 may be used which also reduces waste. Printing an image 116 in the space 120 between color bars 110 provides for maximum image space and allows for the flexibility to provide automatic color control of the color of image 116 that was not previously possible.

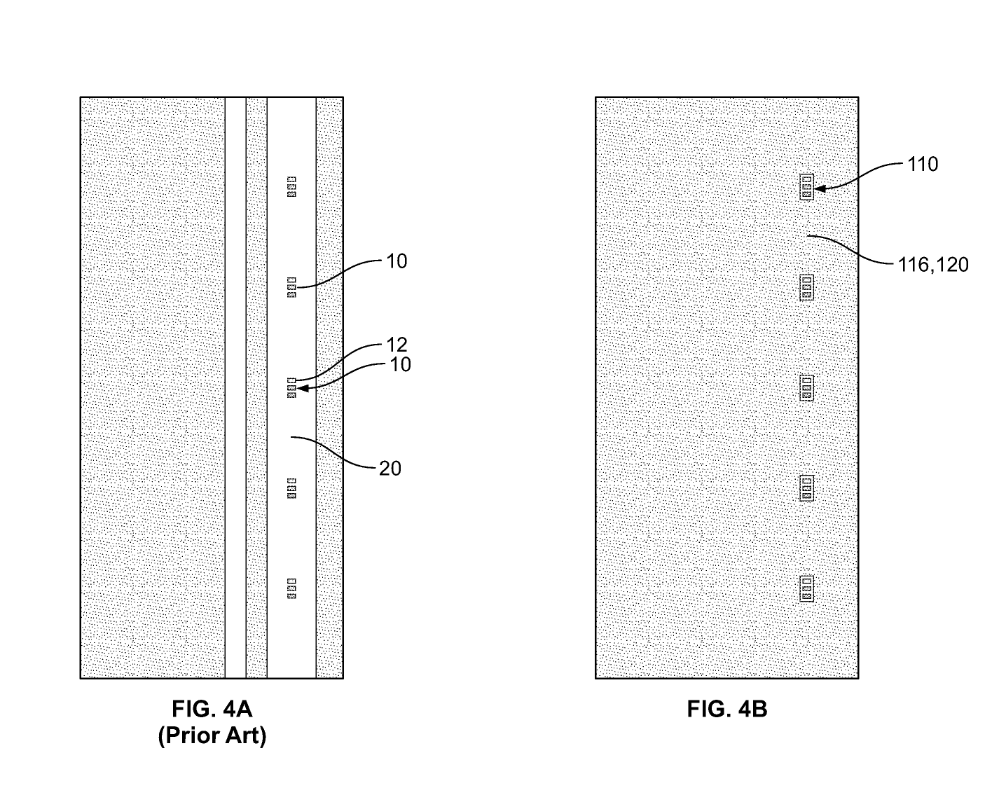

As shown in FIGS. 4A and 4B, the difference between the embedded color bars 110 in accordance with the present invention and the color bars 10 as known in the art is immediately visible. The unprinted stripe 20 of FIG. 4A stands out against the printed substrate.

In contrast, the embedded color bars 110 of the present invention are designed to blend into the printed image 116 by printing the area 120 between bars 110 or adjacent a bar 110. The embedded color bars 110 may also be designed to be incorporated into printed image 116. The visual advantage provided results from a small color bar 110 having small targets 112 with minimal white space therebetween and having color bar 110 surrounded by the image 116.

The color bars 110 may also be used for register control and alignment.

A method of printing embedded color bars is also provided. The color bars 110 are printed on a substrate with a space 120 between each color bar 110 and a printed image 116 is printed in the space 120 between each color bar or adjacent a single color bar 110. Each target 112 in a color bar may be printed by a separate print unit.

In the preceding specification, the invention has been described with reference to specific exemplary embodiments and examples thereof. It will, however, be evident that various modifications and changes may be made thereto without departing from the broader spirit and scope of invention as set forth in the claims that follow. The specification and drawings are accordingly to be regarded in an illustrative manner rather than a restrictive sense.

What is claimed is:

1. A printed substrate comprising:
a plurality of color bars printed on a substrate;
a space between each of the plurality of color bars; and
an image printed in the space between at least two of the color bars.

2. The printed substrate as recited in claim 1, wherein each color bar includes at least one target.

3. The printed substrate as recited in claim 2, wherein each color bar includes at least two targets.

4. The printed substrate or embedded color bar as recited in claim 3 wherein each target is a different color.

5. The printed substrate as recited in claim 1, wherein the color bar is incorporated into the printed image.

6. An embedded color bar comprising:
at least one color bar printed on a substrate;
an image printed adjacent the at least one color bar on the substrate.

7. The embedded color bar as recited in claim 6, wherein the at least one color bar includes two color bars and the image is printed in a space between the at least two color bars on the substrate.

8. The embedded color bar as recited in claim 6, wherein the at least one color bar includes at least one target.

9. The printed substrate as recited in claim 8, wherein each color bar includes at least two targets.

10. The embedded color bar as recited in claim 9, wherein each target is a different color.

11. The embedded color bar as recited in claim 6, wherein the color bar is incorporated into the printed image.

12. A method of printing an embedded color bar comprising the steps of:
printing at least one color bar on a substrate; and
printing an image adjacent the at least one color bar.

13. The method recited in claim 12, wherein at least two color bars are printed on the substrate and the image is printed in an area between the at least two color bars.

14. The method recited in claim 12, further comprising the step of:
printing a second color bar adjacent the image.
